(19) United States
(12) Patent Application Publication
(10) Pub. No.: US 2026/0014470 A1
(43) Pub. Date: Jan. 15, 2026

(54) GAME DISPLAY

(71) Applicant: Tencent Technology (Shenzhen) Company Limited, Shenzhen (CN)

(72) Inventor: Yu GUAN, Shenzhen (CN)

(73) Assignee: Tencent Technology (Shenzhen) Company Limited, Shenzhen, GD (CN)

(21) Appl. No.: 19/334,572

(22) Filed: Sep. 19, 2025

Related U.S. Application Data
(63) Continuation of application No. PCT/CN2024/097404, filed on Jun. 5, 2024.

(30) Foreign Application Priority Data
Jun. 15, 2023 (CN) 202310712863.0

(51) Int. Cl. A63F 13/56; A63F 13/58

(52) U.S. Cl. CPC A63F 13/56; A63F 13/58

(57) ABSTRACT

In a game display method, a virtual game scene of a virtual environment from a target perspective of a first virtual character is output for display on a game interface. The virtual game scene includes a second virtual character. Based on a virtual control region formed by the first virtual character triggering a time-stop state in the virtual game scene, a remaining effective duration of the virtual control region is output for display on the game interface. The second virtual character located within the virtual control region is placed in a restricted state. The remaining effective duration of the virtual control region is increased based on an attack operation performed by the first virtual character on the second virtual character satisfying a preset time-stop continuation condition. Apparatus and non-transitory computer-readable storage medium counterpart embodiments are also contemplated.

### RELATED APPLICATIONS

The present application is a continuation of International Application No. PCT/CN2024/097404, filed on Jun. 5, 2024, which is a continuation of Chinese Patent Application No. 202310712863.0, filed on Jun. 15, 2023, which are hereby incorporated by reference in their entirety.

### FIELD OF THE TECHNOLOGY

This disclosure relates to the field of computer technologies, including to a game picture display method and apparatus, a storage medium, an electronic device, and a computer program product.

### BACKGROUND OF THE DISCLOSURE

In a battle process of a game scene, players perform different attack operations to cause different levels of damage to targets, such as monsters or players, on an attacked side. This damage is usually referred to as direct damage. In addition, indirect damage is also included. For example, after a player hits a target by releasing a preset type of skill, it triggers a status effect of functional damage on the target, inability to move (or reduced movement speed), inability to attack (or reduced attack speed), or inability to release a skill. This status effect is also referred to as a time-stop state of a game picture, or time stop for short.

The so-called time-stop state means that within a preset time, movement speeds or attack speeds of some players or monsters located within a time-stop region in the game picture are reduced to 0 (or extremely slow). For example, a movement speed and an attack speed of a player on the attacking side within the region are not affected, but a movement speed and an attack speed of a target such as a player or a monster in a different camp from the player on the attacking side are both reduced. Therefore, it is beneficial for the player to control the target or perform an attack operation on the target.

In the related art, the time-stop state is generally used as a common one-time control effect, that is, after the time-stop state is triggered, it automatically ends after a duration. Both a start time and an end time of the state are fixed, and cannot be intervened by the player. For example, a remaining effective duration of a 10-second countdown is displayed on the game picture, and when the countdown of 10 seconds ends, the time-stop state automatically ends.

If the player intends to continuously maintain a movement restricted state and/or an attack restricted state of the target, the player needs to re-release a new skill or dodge an attack of the target after the time-stop countdown ends, so that the player re-triggers the time-stop state to continue to control the target and kill the target by using an effective attack. To continuously obtain the time-stop region on a game interface, the player needs to continuously re-trigger the time-stop state after the time-stop countdown ends, and regenerate the time-stop area, which increases complexity of the operation process. In addition, frequent triggering and exiting of display of the time-stop region consumes a large amount of operation time, causing a technical problem of low efficiency during a display process of the game picture.

In view of the problem, no effective solution has been provided yet.

### SUMMARY

Embodiments of this disclosure provide a game picture display method and apparatus, a storage medium, and an electronic device, to resolve at least a technical problem of low efficiency in a display process of the game picture.

According to an aspect of the embodiments of this disclosure, a game picture display method is provided. In the game display method, a virtual game scene of a virtual environment from a target perspective of a first virtual character is output for display on a game interface. The virtual game scene includes a second virtual character. Based on a virtual control region formed by the first virtual character triggering a time-stop state in the virtual game scene, a remaining effective duration of the virtual control region is output for display on the game interface. The second virtual character located within the virtual control region is placed in a restricted state. The remaining effective duration of the virtual control region is increased based on an attack operation performed by the first virtual character on the second virtual character satisfying a preset time-stop continuation condition.

According to an aspect of the embodiments of this disclosure, a processing apparatus is provided. The processing apparatus includes processing circuitry that is configured to output for display, on a game interface, a virtual game scene of a virtual environment from a target perspective of a first virtual character, the virtual game scene including a second virtual character. The processing circuitry is configured to output for display, based on a virtual control region formed by the first virtual character triggering a time-stop state in the virtual game scene, a remaining effective duration of the virtual control region on the game interface. The second virtual character located within the virtual control region is placed in a restricted state. The processing circuitry is configured to increase the remaining effective duration of the virtual control region based on an attack operation performed by the first virtual character on the second virtual character satisfying a preset time-stop continuation condition.

According to an aspect of the embodiments of this disclosure, a game picture display method is provided. The method includes: displaying, on a game interface, a game picture corresponding to a virtual game scene from a target perspective of a first virtual character, the virtual game scene including the first virtual character and a second virtual character in a different camp from the first virtual character; displaying, in response to a virtual control region formed by the first virtual character triggering a time-stop state in the virtual game scene, a remaining effective duration of the virtual control region on the game interface, the second virtual character located within the virtual control region being in a movement restricted state and/or an attack restricted state; and increasing the remaining effective duration of the virtual control region in response to an attack operation performed by the first virtual character on the second virtual character satisfying a preset time-stop continuation condition.

In some embodiments, the increasing the remaining effective duration of the virtual control region in response to an attack operation performed by the first virtual character on the second virtual character satisfying a preset time-stop continuation condition includes: increasing the remaining effective duration of the virtual control region when the attack operation performed by the first virtual character on the second virtual character triggers the time-stop state again in a case that the remaining effective duration is greater than 0; or increasing a value of virtual energy in a case that a preset type of attack operation performed by the first virtual character hits the second virtual character located within the virtual control region; and the remaining effective duration of the virtual control region is increased in a case that the value of the virtual energy reaches a preset energy threshold and the remaining effective duration is greater than 0.

In some embodiments, the increasing a value of virtual energy in a case that a preset type of attack operation performed by the first virtual character hits the second virtual character located within the virtual control region includes: increasing the value of the virtual energy in a case that a continuous attack operation performed by the first virtual character hits the second virtual character located within the virtual control region; or increasing the value of the virtual energy in a case that a combined attack operation performed by the first virtual character hits the second virtual character located within the virtual control region.

In some embodiments, the increasing the value of the virtual energy in a case that a continuous attack operation performed by the first virtual character hits the second virtual character located within the virtual control region includes: increasing the value of the virtual energy in a case that a current attack operation performed by the first virtual character hits the second virtual character, and a time interval between the current attack operation and a previous attack operation performed by the first virtual character that hits the second virtual character is less than or equal to a first preset duration.

In some embodiments, the method further includes: reducing the value of the virtual energy or setting the value of the virtual energy to 0 in a case that the current attack operation performed by the first virtual character hits the second virtual character, and the time interval between the current attack operation and the previous attack operation performed by the first virtual character that hits the second virtual character is greater than the first preset duration.

In some embodiments, reducing the value of the virtual energy or setting the value of the virtual energy to 0 in a case that the current attack operation performed by the first virtual character hits the second virtual character, and the time interval between the current attack operation and the previous attack operation performed by the first virtual character that hits the second virtual character is greater than the first preset duration.

In some embodiments, the method further includes: reducing the value of the virtual energy or setting the value of the virtual energy to 0 in a case that the attack operation performed by the second virtual character hits the first virtual character.

In some embodiments, the increasing a value of virtual energy in a case that a preset type of attack operation performed by the first virtual character hits the second virtual character located within the virtual control region includes: increasing the value of the virtual energy by a preset value in a case that a preset type of attack operation performed by the first virtual character hits the second virtual character located within the virtual control region; or increasing the value of the virtual energy by a product of the preset value and N in a case that the preset type of attack operation performed by the first virtual character hits N parts of the second virtual character located within the virtual control region, N being a positive integer greater than or equal to 2; or determining, based on a preset probability, whether to increase the value of the virtual energy to the preset energy threshold in a case that the preset type of attack operation performed by the first virtual character hits the second virtual character located within the virtual control region; increasing the value of the virtual energy to the preset energy threshold in a case that it is determined to increase the value of the virtual energy to the preset energy threshold; and increasing the value of the virtual energy by the preset value in a case that it is determined to not increase the value of the virtual energy to the preset energy threshold.

In some embodiments, the determining, based on a preset probability, whether to increase the value of the virtual energy to the preset energy threshold includes: determining, based on a preset first probability, whether to increase the value of the virtual energy to the preset energy threshold in a case that the value of the virtual energy falls within a first value range; and determining, based on a preset second probability, whether to increase the value of the virtual energy to the preset energy threshold in a case that the value of the virtual energy falls within a second value range, values within the first value range being all less than values within the second value range, and the first probability being less than the second probability.

In some embodiments, the method further includes: setting the value of the virtual energy to 0 in a case that the remaining effective duration of the virtual control region is increased.

In some embodiments, the virtual game scene further includes: a third virtual character; and the method further includes: forming the virtual control region in the virtual game scene in a case that a target virtual skill released by the first virtual character hits the second virtual character, the second virtual character being located within the virtual control region, and the virtual control region being a fixed region, or the virtual control region moving with the second virtual character; or forming the virtual control region in the virtual game scene in a case that the target virtual skill released by the first virtual character hits the third virtual character, the third virtual character being a virtual character in a different camp from the first virtual character, the third virtual character being in the same camp as or a different camp from the second virtual character, the third virtual character being located within the virtual control region, and the virtual control region being a fixed region, or the virtual control region moving with the third virtual character; or forming the virtual control region in the virtual game scene in a case that the first virtual character successfully dodges an attack operation performed by the second virtual character on the first virtual character, the second virtual character being located within the virtual control region, and the virtual control region being a fixed region, or the virtual control region moving with the second virtual character; and forming the virtual control region in the virtual game scene in a case that the first virtual character successfully dodges an attack operation performed by the third virtual character on the first virtual character, the third virtual character being a virtual character in a different camp from the first virtual character, the third virtual character being in the same camp as or a different camp from the second virtual character, the third virtual character being located within the virtual control region, and the virtual control region being a fixed region, or the virtual control region moving with the third virtual character.

In some embodiments, the method further includes: displaying the remaining effective duration of the virtual control region on a game picture of the second virtual character in a case that the second virtual character is located within the virtual control region; and/or displaying, on the game picture of the second virtual character, prompt information of the attack operation performed by the first virtual character in a case that the second virtual character is located within the virtual control region, the prompt information being configured for prompting the second virtual character to dodge the attack operation performed by the first virtual character.

In some embodiments, the virtual game scene further includes: a fourth virtual character; and the method further includes: removing the movement restricted state and/or the attack restricted state of the second virtual character located within the virtual control region or reducing a range of the virtual control region in a case that the attack operation performed by the second virtual character hits the first virtual character; or removing the movement restricted state and/or the attack restricted state of the second virtual character located within the virtual control region or reducing a range of the virtual control region in a case that an attack operation performed by the fourth virtual character hits the first virtual character, the fourth virtual character being a virtual character in the same camp as the second virtual character, and the fourth virtual character being located within the virtual control region or being located outside the virtual control region.

In some embodiments, the game interface displays an energy ring in response to the virtual control region formed by the first virtual character triggering the time-stop state in the virtual game scene, the energy ring including a ring body and a central region located on an inner side of the ring body; and the remaining effective duration of the virtual control region is displayed on the central region, and the ring body is configured to display the value of the virtual energy.

According to an aspect of the embodiments of this disclosure, a game picture display apparatus is provided. The apparatus includes: a first display unit, configured to display, on a game interface, a game picture corresponding to a virtual game scene from a target perspective of a first virtual character, the virtual game scene including the first virtual character and a second virtual character in a different camp from the first virtual character; a first processing unit, configured to: display, in response to a virtual control region formed by the first virtual character triggering a time-stop state in the virtual game scene, a remaining effective duration of the virtual control region on the game interface, the second virtual character located within the virtual control region being in a movement restricted state and/or an attack restricted state; and a second processing unit, configured to increase the remaining effective duration of the virtual control region in response to an attack operation performed by the first virtual character on the second virtual character satisfying a preset time-stop continuation condition.

According to still another aspect of the embodiments of this disclosure, a non-transitory computer-readable storage medium is further provided. The non-transitory computer-readable storage medium stores instruction which, when executed by a processor, cause the processor to perform the foregoing game picture display methods.

According to still another aspect of the embodiments of this disclosure, a computer program product is further provided. The computer program product includes a computer program/instructions, the computer program/instructions, when executed by a processor, implementing the operations of the foregoing methods.

According to still another aspect of the embodiments of this disclosure, an electronic device is further provided. The electronic device includes a memory and a processor, the memory having a computer program stored therein, and the processor being configured to perform the foregoing game picture display methods through the computer program.

According to still another aspect of the embodiments of this disclosure, a program product is further provided. The program product includes: a computer program, the computer program, when executed by a processor, implementing the foregoing game picture display methods.

According to the foregoing embodiments provided by this disclosure, in a process of displaying the remaining effective duration of the virtual control region, when the value of the virtual energy reaches the preset energy threshold, the remaining effective duration of the virtual control region can be increased by using the attack operation continuously performed by the first virtual character. In other words, in the process of displaying the remaining effective duration of the virtual control region, the count of the remaining effective duration can be increased by using the attack operation performed by the first virtual character, thereby simplifying the operation process of changing the remaining effective duration of the virtual control region in the related art, reducing the time consumed for forming the virtual control region again, and achieving the technical effect of improving the efficiency of displaying the game picture.

### BRIEF DESCRIPTION OF THE DRAWINGS

The accompanying drawings described herein are intended to provide a further understanding of this disclosure, and constitute a part of this disclosure. Examples of embodiments of this disclosure and descriptions thereof are for explaining this disclosure, and do not constitute a limitation to the scope of this disclosure. In the accompanying drawings:

FIG. 1 is a schematic diagram of an application scenario of a game picture display method according to an embodiment of this disclosure.

FIG. 2 is a flowchart of a game picture display method according to an embodiment of this disclosure.

FIG. 3 is a schematic diagram of increasing a remaining effective duration of a virtual control region according to an embodiment of this disclosure.

FIG. 4 is a schematic diagram of an effect of a virtual control region according to an exemplary embodiment of this disclosure.

FIG. 5 is a schematic diagram 1 of increasing or reducing a value of virtual energy according to an embodiment of this disclosure.

FIG. 6 is a schematic diagram 2 of increasing or reducing a value of virtual energy according to an embodiment of this disclosure.

FIG. 7 is a schematic diagram 3 of increasing or reducing a value of virtual energy according to an embodiment of this disclosure.

FIG. 8 is a schematic diagram of two manners of increasing a value of virtual energy according to an embodiment of this disclosure.

FIG. 9 is a schematic diagram of instantly filling an energy ring based on a preset probability according to an embodiment of this disclosure.

FIG. 10 is a schematic diagram of a process of instantly filling an energy ring according to an embodiment of this disclosure.

FIG. 11 is a schematic diagram of a method for controlling a virtual control region according to an embodiment of this disclosure.

FIG. 12 is a schematic diagram of triggering to form a virtual control region according to an embodiment of this disclosure.

FIG. 13 is a schematic diagram of another method for displaying a virtual control region according to an embodiment of this disclosure.

FIG. 14 is an overall flowchart of a game picture display method according to an embodiment of this disclosure.

FIG. 15 is a schematic diagram of a structure of a game picture display apparatus according to an embodiment of this disclosure.

FIG. 16 is a schematic diagram of a structure of an electronic device according to an embodiment of this disclosure.

### DESCRIPTION OF EMBODIMENTS

Example of technical solutions in embodiments of this disclosure are described below with reference to the accompanying drawings. The described embodiments are merely some rather than all of the embodiments of this disclosure. Other embodiments obtained by a person of ordinary skill in the art based on the embodiments of this disclosure shall fall within the scope of this disclosure.

Examples of terms involved in the aspects of the disclosure are briefly introduced. The descriptions of the terms are provided as examples only and are not intended to limit the scope of the disclosure.

In the specification, claims, and accompanying drawings of this disclosure, the terms “first”, “second”, and the like are intended to distinguish between similar objects but do not necessarily indicate a specific order or sequence. Data used in such a way is interchangeable in proper circumstances, so that the embodiments of this disclosure described herein can be implemented in other orders than the order illustrated or described herein. In addition, the terms “comprise”, “include”, and any other variants thereof mean to cover non-exclusive inclusion. For example, a process, method, system, product, or device that includes a series of operations or units is not necessarily limited to those expressly listed operations or units, but may include other operations or units not expressly listed or inherent to the process, method, product, or device.

### Explanation of Examples of Terms

Mobile terminal: It generally refers to a mobile terminal, and includes, but is not limited to, all handheld portable gaming devices.

MMORPG game: Massive multiplayer online role-playing game. In an example, the term can be used in a narrow sense in this disclosure, specifically referring to a game in which, from a third-person perspective, a player may control an independent 3D character model representing the player, and perform real-time interactions such as real-time movement or real-time combat in a virtual world.

Control effect: In the MMORPG game, after the player releases some skills/attacks/items on a target, a status effect of functional damage (non-direct damage) such as inability to move/attack/release a skill on the target is referred to as a control effect.

Time-stop: It is an abbreviation of a time-stop state. When this state is triggered, a specific region around the player changes to a time-stop region, which is also referred to as a time-stop field in some applications, and a color of the time-stop state may be different from that of a normal state. Within the time-stop region, only player characters may freely move, movement speeds and attack speeds of targets such as all monsters are reduced to 0 (or extremely slow), and the speed of bullets fired by the monsters is also reduced to 0 (or extremely slow).

Combo: It refers to consecutive hits. The result of the player achieving continuous damage to the target through operations of the player is referred to as a combo. The combo is countable, with the combo count increasing by 1 after each successful execution.

Multi-part hit: It is a special mechanism of this product. The target includes a plurality of parts, and each part is an independent hit zone, capable of independently recording damage and combos. For example, when the player performs one attack (damage 100) and hits three parts, each part triggers one 100 damage hit, and each part records one combo, with a total damage of 100×3=300 and the combo count increasing by 3.

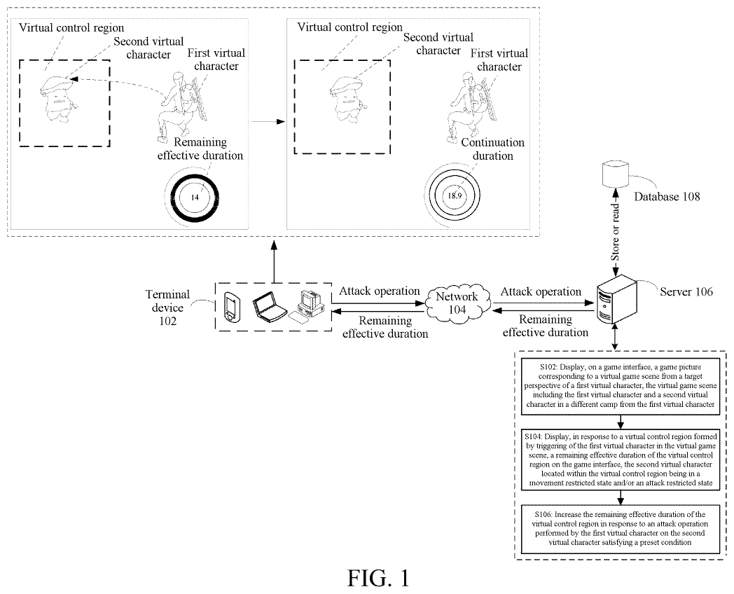

According to an aspect of the embodiments of this disclosure, a game picture display method is provided. In an implementation, the game picture display method may be applied to, but is not limited to, an application scenario shown in FIG. 1. In the application scenario shown in FIG. 1, a terminal device 102 may, but is not limited to, communicate with a server 106 through a network 104, and the server 106 may, but is not limited to, perform an operation, for example, a data write operation or a data read operation, on a database 108. The terminal device 102 may include, but is not limited to, a human-computer interaction screen, processing circuitry (for example, a processor), and a memory. The human-computer interaction screen may be, but is not limited to, configured to display a remaining effective duration of a virtual control region on the terminal device 102, a first virtual character, and a value of virtual energy. The processor may be, but is not limited to, configured to perform a corresponding operation in response to a human-computer interaction operation, or generate a corresponding instruction, and send the generated instruction to the server 106. The memory is configured to store related processing data, such as the value of the virtual energy and a movement speed and an attack speed of a virtual character.

In an example, the following operations in the game picture display method may be performed on the server 106.

Operation S102: Display, on a game interface, a game picture corresponding to a virtual game scene from a target perspective of a first virtual character, the virtual game scene including the first virtual character and a second virtual character in a different camp from the first virtual character.

Operation S104: Display, in response to a virtual control region formed by triggering of the first virtual character in the virtual game scene, a remaining effective duration of the virtual control region on the game interface, the second virtual character located within the virtual control region being in a movement restricted state and/or an attack restricted state.

Operation S106: Increase the remaining effective duration of the virtual control region in response to an attack operation performed by the first virtual character on the second virtual character satisfying a preset condition.

By using the foregoing manner, in a process of displaying the remaining effective duration of the virtual control region, when the value of the virtual energy reaches a preset energy threshold, the remaining effective duration of the virtual control region can be increased by using the attack operation continuously performed by the first virtual character. In other words, in the process of displaying the remaining effective duration of the virtual control region, the count of the remaining effective duration can be increased by using the attack operation performed by the first virtual character, thereby simplifying the operation process of changing the remaining effective duration of the virtual control region in the related art, reducing the time consumed for forming the virtual control region again, and achieving the technical effect of improving the efficiency of displaying the game picture.

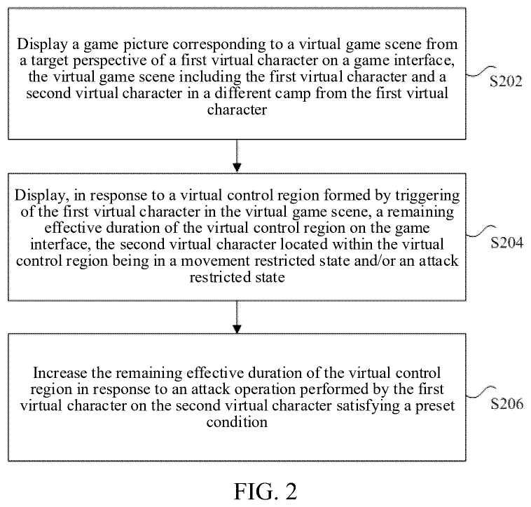

To resolve the problem of low efficiency in a display process of a game picture, an embodiment of this disclosure provides a game picture display method. FIG. 2 is a flowchart of a game picture display method according to an embodiment of this disclosure. The procedure includes the following operations.

Operation S202: Display, on a game interface, a game picture corresponding to a virtual game scene from a target perspective of a first virtual character, the virtual game scene including the first virtual character and a second virtual character in a different camp from the first virtual character. In an example, a virtual game scene of a virtual environment from a target perspective of a first virtual character is output for display on a game interface. The virtual game scene includes a second virtual character.

Operation S204: Display, in response to a virtual control region formed by the first virtual character triggering a time-stop state in the virtual game scene, a remaining effective duration of the virtual control region on the game interface, the second virtual character located within the virtual control region being in a movement restricted state and/or an attack restricted state. The virtual control region herein may be understood as the foregoing time-stop region. In an example, based on a virtual control region formed by the first virtual character triggering a time-stop state in the virtual game scene, a remaining effective duration of the virtual control region is output for display on the game interface. The second virtual character located within the virtual control region is placed in a restricted state.

Operation S206: Increase the remaining effective duration of the virtual control region in response to an attack operation performed by the first virtual character on the second virtual character satisfying a preset time-stop continuation condition. “Time-stop continuation” refers to extending a time-stop duration of a time-stop state before a current time-stop countdown of the time-stop state ends, that is, increasing the remaining effective duration of the virtual control region before the remaining effective duration reaches 0. In an example, the remaining effective duration of the virtual control region is increased based on an attack operation performed by the first virtual character on the second virtual character satisfying a preset time-stop continuation condition.

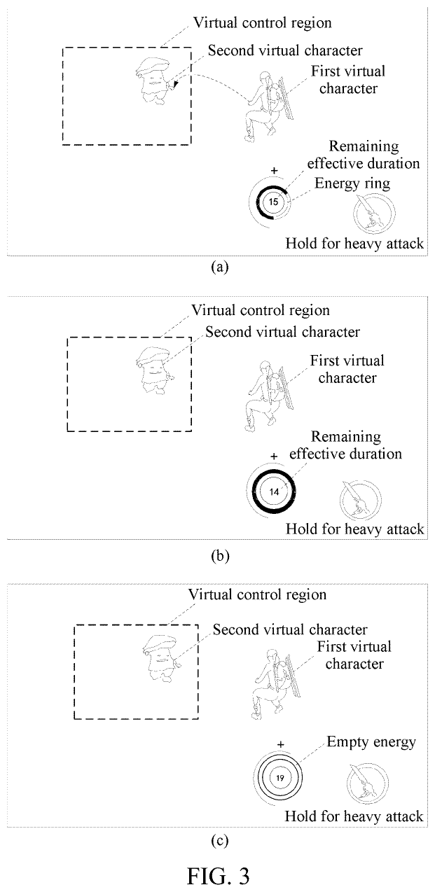

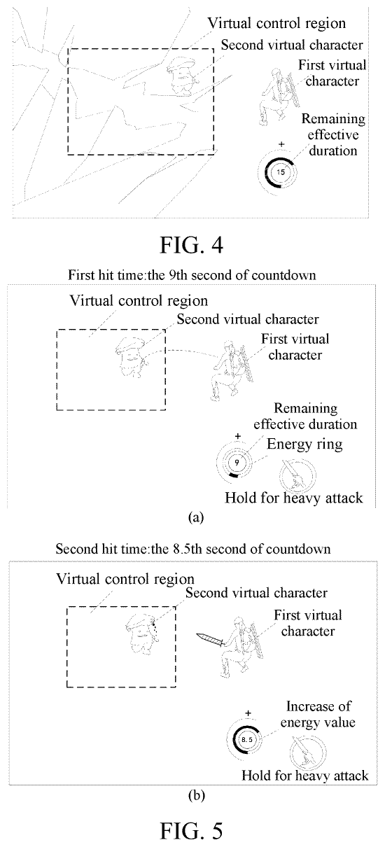

Assuming that the virtual game scene includes the first virtual character and the second virtual character, in a case that the first virtual character releases a special attack skill and hits the second virtual character, the virtual control region (which may also be understood as the time-stop region) and an energy ring (which may also be understood as a time-stop continuation energy ring) shown in (a) in FIG. 3 are generated around the second virtual character. Colors of some virtual game scenes in the virtual control region may change to black and white, with a display effect of spatial fragmentation. For example details, refer to FIG. 4.

The second virtual character located within the virtual control region is in the movement restricted state and/or the attack restricted state. The movement restricted state and/or the attack restricted state includes, but is not limited to, at least one of the following.

(1) The movement speed of the second virtual character is reduced, and/or the attack speed of the second virtual character is reduced.

For example, a flight velocity of a bullet fired by the second virtual character is 0.01 of a normal flight velocity.

(2) In a case that the second virtual character can release N skills, the second virtual character in the movement restricted state and/or the attack restricted state can only release some of the N skills.

(3) An attack operation performed by the second virtual character causes a low damage index to an attacked side. For example, the damage index is only 0.1 of a normal damage index.

(4) The second virtual character cannot perform the attack operation.

In a case that the first virtual character is a virtual character controlled by the player, the target perspective may be, but is not limited to, a first-person perspective or a third-person perspective.

In addition to the foregoing the virtual control region formed by triggering of the first virtual character, another trigger manner is further included: If the first virtual character successfully dodges before being hit by an attack of the second virtual character, the virtual control region is also generated around the second virtual character.

It is clear that, the second virtual character may be, but is not limited to, a virtual character in a different camp from the first virtual character or a non-player-controlled virtual character, for example, a monster in an NPC.

While the virtual control region is formed on the game picture, an energy ring shown in FIG. 3 is displayed. The energy ring includes an outer ring body and a central region located on an inner side of the ring body. The ring body is configured for displaying the value of the virtual energy. For example, a ratio of a value of current virtual energy to total full-ring virtual energy may be displayed based on a filled area of a blank ring body. The central region is configured for displaying the remaining effective duration of the virtual control region, and the remaining effective duration may be displayed in a form of a number, or may be displayed in a form of a progress bar. For example, assuming that a current effective duration of the virtual control region is 20 s, countdown information of 20 s (which may also be understood as a remaining effective duration of this time-stop) is displayed in the central region of the energy ring.

The second virtual character located within the virtual control region is in the movement restricted state and/or the attack restricted state, which is beneficial for the first virtual character to attack the second virtual character. Therefore, the first virtual character controlled by the player can continuously increase the remaining effective duration of the virtual control region.

During specific implementation, there may be a plurality of implementations of the preset time-stop continuation condition. For example, in an example, an attack operation performed by the first virtual character on the second virtual character satisfying a preset time-stop continuation condition may be that: In the time-stop state, the player performs again the attack operation triggering the time-stop state, and confirms that the time-stop continuation condition is satisfied. For example, in a case that the current remaining effective duration is greater than 0, if the attack operation performed by the first virtual character on the second virtual character triggers the time-stop state again, it is determined that the time-stop continuation condition is satisfied, and the remaining effective duration of the virtual control region may be increased. In another example, an attack operation performed by the first virtual character on the second virtual character satisfying a preset time-stop continuation condition may also be that: An intermediate value such as a value of virtual energy is preset. The player performs an attack operation of increasing the value of the virtual energy in the time-stop state. When the value of the virtual energy reaches a set threshold, it is determined that the time-stop continuation condition is satisfied.

For the second case, for example, in an example, the remaining effective duration of the virtual control region may be increased in a case that the following preset time-stop continuation condition is satisfied, which specifically includes:

the value of the virtual energy is increased in a case that a preset type of attack operation performed by the first virtual character hits the second virtual character located within the virtual control region; and the remaining effective duration of the virtual control region is increased in a case that the value of the virtual energy reaches a preset energy threshold and the remaining effective duration is greater than 0. In this example, the preset time-stop continuation condition may be understood as that the value of the virtual energy reaches the preset energy threshold and the remaining effective duration is greater than 0. A condition for triggering the value of the virtual energy to reach the preset energy threshold is that the preset type of attack operation performed by the first virtual character hits the second virtual character located within the virtual control region.

In other words, before the countdown of the remaining effective duration ends, in a case that the first virtual character performs the preset type of attack operation and hits the second virtual character located within the virtual control region, energy in the energy ring is increased. For example, assuming that, as shown in (a) in FIG. 3, at the 15th second of the countdown, the first virtual character performs the attack operation and hits the second virtual character, the virtual energy in the energy ring increases to a state shown in (b) in FIG. 3.

Because the virtual energy in the energy ring is full, the remaining effective duration of the virtual control region is increased. For example, at the 14th second of the countdown, a delay duration of 5 s is increased, that is, the remaining effective duration is increased to 19 s shown in (c) in FIG. 3.

In addition, when the remaining effective duration is 0, the virtual control region is canceled, and movement speeds and/or attack speeds of virtual characters (including the second virtual character and another virtual character) in the virtual control region restore to normal.

In a process of displaying the virtual control region (time-stop), the preset type of attack operation performed by the first virtual character can extend the time-stop duration, and eliminate the need to repeatedly generate and exit the virtual control region. This reduces the display switching frequency of the virtual control region, and saves time consumed by repeatedly forming the virtual control region, thereby improving display efficiency of the entire time-stop process, and making the entire time-stop process full of variation and a sense of surprise. In addition, it also resolves the problem in the related art of a lack of enjoyment in a game play process due to inability of the player to intervene in the time-stop duration (a start time and an end time of the time-stop are fixed).

In an implementation, the increasing the virtual energy in the energy ring by the preset type of attack operation performed by the first virtual character includes:
increasing the value of the virtual energy in a case that a continuous attack operation performed by the first virtual character hits the second virtual character located within the virtual control region; or
increasing the value of the virtual energy in a case that a combined attack operation performed by the first virtual character hits the second virtual character located within the virtual control region.

In the embodiments of this disclosure, the preset type of attack operation performed by the first virtual character includes, but is not limited to, a continuous attack (combo) operation, a combined attack operation, or the like. The continuous attack means that a time difference between effective time points at which a plurality of attack operations cause damage to the second virtual character is less than a preset time threshold.

Specifically, it includes: increasing the value of the virtual energy in a case that a current attack operation performed by the first virtual character hits the second virtual character, and a time interval between the current attack operation and a previous attack operation performed by the first virtual character that hits the second virtual character is less than or equal to a first preset duration.

For example, as shown in FIG. 5, assuming that at the 9th second of the countdown, the first virtual character performs a throwable attack operation and hits the second virtual character, energy in the energy ring increases from 0 to a level shown in (a) in FIG. 5; and at the 8.5th second of the countdown, the first virtual character stabs the second virtual character with a virtual sword in the hand, energy in the energy ring increases again and increases to a state shown in (b) in FIG. 5.

Because a difference between an effective time point at which the second virtual character causes the second damage and an effective time point at which the second virtual character causes the first damage is 0.5, which is less than a preset time interval of Is, the two attack operations form a combo operation, that is, a continuous attack operation (combo) is successfully continued. Therefore, after the second attack operation, energy in the energy ring continues to be increased.

Conversely, in a case that the current attack operation performed by the first virtual character hits the second virtual character, and the time interval between the current attack operation and the previous attack operation performed by the first virtual character that hits the second virtual character is greater than the first preset duration, the value of the virtual energy may be reduced, or the value of the virtual energy may be set to 0.

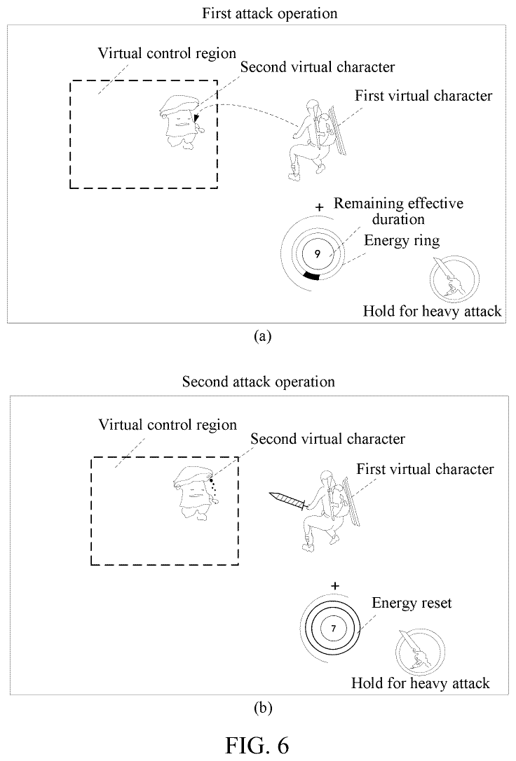

For example, assuming that time at which the first attack operation performed by the first virtual character is still the 9th second of the countdown, if time at which the second virtual character is hit for the second time is the 7th second of the countdown, after the second attack operation is performed, in an implementation, the energy in the energy ring may be cleared or the energy in the energy ring may be reduced. This is because a time interval between the two attack operations is greater than the preset time interval is. Therefore, the combo fails to be continued, and the energy in the time-stop continuation energy ring may be cleared or the energy in the energy ring may be reduced as shown in (b) in FIG. 6.

In addition, in a countdown process of the remaining effective duration, if the first virtual character is hit by the second virtual character or another virtual character, it is directly considered that the combo fails to be continued. In this case, the energy in the energy ring is reduced or the energy in the energy ring is directly cleared.

According to the foregoing embodiments provided by this disclosure, in a process of displaying the remaining effective duration of the virtual control region, when the value of the virtual energy reaches the preset energy threshold, the remaining effective duration of the virtual control region can be increased by using the attack operation continuously performed by the first virtual character. In other words, in the process of displaying the remaining effective duration of the virtual control region, the count of the remaining effective duration can be increased by using the attack operation performed by the first virtual character, thereby simplifying the operation process of changing the remaining effective duration of the virtual control region in the related art, reducing the time consumed for forming the virtual control region again, and achieving the technical effect of improving the efficiency of displaying the game picture.

In another implementation, the increasing the value of the virtual energy in a case that a combined attack operation performed by the first virtual character hits the second virtual character located within the virtual control region includes:

increasing the value of the virtual energy in a case that a set of attack operations sequentially performed by the first virtual character all hit the second virtual character within a second preset duration, the set of attack operations including a plurality of types of attack operations.

In the embodiments of this disclosure, in addition to that the second virtual character is hit by the continuous attack operation, the second virtual character located within the virtual control region may be hit by a combined attack operation performed by the first virtual character, thereby increasing the energy in the energy ring.

The combined attack operation may be, but is not limited to, a set of combined skills. For example, if the second virtual character is attacked sequentially according to an order such as assassination, shield strike, and throwable attacks, and each skill hits the second virtual character, the energy in the energy ring is increased.

In an example, the method further includes:

reducing the value of the virtual energy or setting the value of the virtual energy to 0 in a case that the attack operation performed by the second virtual character hits the first virtual character.

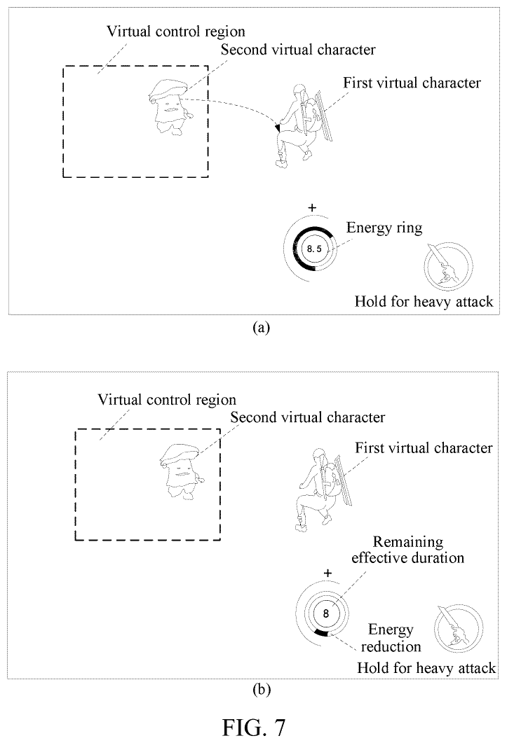

As shown in (a) in FIG. 7, assuming that when the remaining effective duration of the virtual control region is 8.5 s, the second virtual character located within the virtual control region performs the attack operation and hits the first virtual character, the energy in the energy ring is reduced from a value shown in (a) in FIG. 7 to a value shown in (b) in FIG. 7, or the energy in the energy ring is directly cleared.

According to the foregoing embodiments, determining to increase or reduce the energy in the energy ring based on the preset type of attack operation performed by the first virtual character not only improves the efficiency of displaying a game picture, but also makes the entire time-stop process full of variation, also increasing the fun of the game.

In an implementation, the increasing a value of virtual energy in a case that a preset type of attack operation performed by the first virtual character hits the second virtual character located within the virtual control region includes:
increasing the value of the virtual energy by a preset value in a case that a preset type of attack operation performed by the first virtual character hits the second virtual character located within the virtual control region; or
increasing the value of the virtual energy by a product of the preset value and N in a case that the preset type of attack operation performed by the first virtual character hits N parts of the second virtual character located within the virtual control region, N being a positive integer greater than or equal to 2; or
determining, based on a preset probability, whether to increase the value of the virtual energy to the preset energy threshold in a case that the preset type of attack operation performed by the first virtual character hits the second virtual character located within the virtual control region; increasing the value of the virtual energy to the preset energy threshold in a case that it is determined to increase the value of the virtual energy to the preset energy threshold; and increasing the value of the virtual energy by the preset value in a case that it is determined to not increase the value of the virtual energy to the preset energy threshold.

Assuming that an energy value is 100 when the energy of the energy ring is full, in a case that the preset type of attack operation performed by the first virtual character hits the second virtual character located within the virtual control region, a manner of increasing the energy in the energy ring includes at least one of the following:

### (1) Increase by a Preset Value

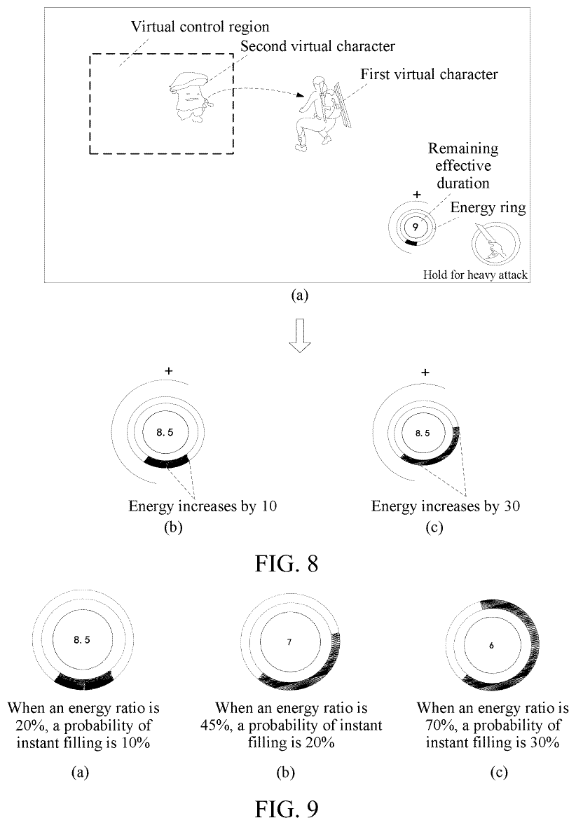

Each time the first virtual character successfully performs a combo, and each attack in the combo hits one part in a body of the second virtual character, the energy in the energy ring increases by a preset value, such as 10, as shown in FIG. 8.

It is assumed that the body of the second virtual character is formed by a plurality of parts, and each part is an independent attack zone capable of independently recording damage and combos. For example, when the first virtual character performs one attack (damage 100) and hits three parts, each part triggers one 100 damage hit, and each part records one combo, with a total damage of 100×3=300 and the combo count increasing by 3. Meanwhile, the energy in the energy ring increases by three times the preset value, as shown in (c) in FIG. 8, for a total increase of 10×3=30.

In a case that the preset type of attack operation (for example, each attack in the combo) performed by the first virtual character hits the second virtual character located within the virtual control region, instant filling of the energy ring can be triggered based on the preset probability.

In an example, the determining, based on a preset probability, whether to increase the value of the virtual energy to the preset energy threshold includes:
determining, based on a preset first probability, whether to increase the value of the virtual energy to the preset energy threshold in a case that the value of the virtual energy falls within a first value range; and
determining, based on a preset second probability, whether to increase the value of the virtual energy to the preset energy threshold in a case that the value of the virtual energy falls within a second value range, values within the first value range being all less than values within the second value range, and the first probability being less than the second probability.

For example, assuming that the value of the virtual energy is divided into the following three different value ranges based on a ratio of an energy value currently filled in the energy ring to an energy value 100 when the energy ring is filled, a probability of instant filling of the energy ring is determined based on a value range within which the value of the virtual energy falls:
(1) When an energy ratio is less than 30%, the probability of instant filling of the energy ring is 10%.
(2) When the energy ratio is greater than or equal to 30% and less than 60%, the probability of instant filling of the energy ring is 20%.
(3) When the energy ratio is greater than or equal to 60%, the probability of instant filling of the energy ring is 30%.

In a specific embodiment, as shown in FIG. 9, when a ratio of virtual energy in the energy ring is 20%, the probability of instant filling of the energy ring is 10%; when a ratio of the virtual energy in the energy ring is 45%, the probability of instant filling of the energy ring is 20%; and when a ratio of the virtual energy in the energy ring is 70%, the probability of instant filling of the energy ring is 30%.

In other words, in a case that the attack operation performed by the first virtual character hits the second virtual character located within the virtual control region, the more energy filled in the energy ring indicates a higher probability (preset probability) of increasing the value of the virtual energy to the preset energy threshold. As the value of virtual energy already accumulated in the energy ring increases, a probability of triggering instant filling of the energy ring also increases.

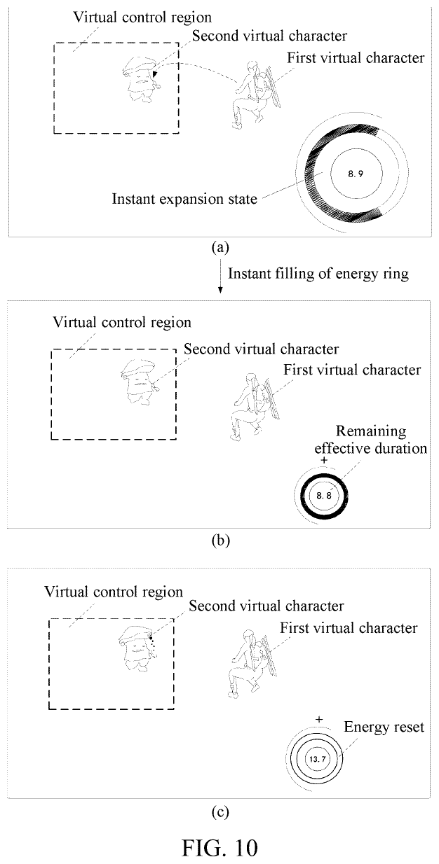

In addition, when instant filling of the energy ring is triggered, the energy ring undergoes a process of instant expansion followed by contraction. For example, as shown in (a) in FIG. 10, assuming that at the 8.9th second of the countdown, an attack operation performed by the first virtual character hits the second virtual character located within the virtual control region, and the attack operation triggers instant filling of the energy ring, the energy ring instantly expands and then contracts to a normal size shown in (b) in FIG. 10.

After the energy ring is filled, at the 8.7th second of the countdown, the remaining effective duration of the virtual control region is increased, and the energy in the energy ring is automatically cleared, that is, the energy ring is reset, which specifically includes:

setting the value of the virtual energy to 0 in a case that the remaining effective duration of the virtual control region is increased.

Assuming that after the energy ring is instantly filled, countdown time increases by 5 s, as shown in (b) and (c) in FIG. 10, the remaining effective duration is increased from current 8.8 s to 13.7 s.

With reference to the analysis of the foregoing embodiments, manners of filling the energy ring include, but are not limited to, the following two types.

First type: The second virtual character located within the virtual control region is hit by the preset type of attack operation performed by the first virtual character, the value of the virtual energy is increased by the preset value, and the virtual energy in the energy ring is gradually accumulated by a plurality of attack operations until the energy ring is filled. In a process of accumulating the virtual energy, a time interval between any two attack operations performed by the first virtual character is less than the first preset duration.

Second type: Instant filling of the energy ring is triggered based on a value of virtual energy currently in the energy ring and the preset probability. In other words, each time the second virtual character is hit, there is a certain probability that the energy ring is directly filled, which increases a sense of surprise in a game play process and improves the diversity of the game picture.

In an example, the method further includes:
forming the virtual control region in the virtual game scene in a case that a target virtual skill released by the first virtual character hits the second virtual character, the second virtual character being located within the virtual control region, and the virtual control region being a fixed region, or the virtual control region moving with the second virtual character; or
forming the virtual control region in the virtual game scene in a case that the target virtual skill released by the first virtual character hits a third virtual character, the third virtual character being a virtual character in a different camp from the first virtual character, the third virtual character being in the same camp as or a different camp from the second virtual character, the third virtual character being located within the virtual control region, and the virtual control region being a fixed region, or the virtual control region moving with the third virtual character; or
forming the virtual control region in the virtual game scene in a case that the first virtual character successfully dodges an attack operation performed by the second virtual character on the first virtual character, the second virtual character being located within the virtual control region, and the virtual control region being a fixed region, or the virtual control region moving with the second virtual character; and
forming the virtual control region in the virtual game scene in a case that the first virtual character successfully dodges an attack operation performed by a third virtual character on the first virtual character, the third virtual character being a virtual character in a different camp from the first virtual character, the third virtual character being in the same camp as or a different camp from the second virtual character, the third virtual character being located within the virtual control region, and the virtual control region being a fixed region, or the virtual control region moving with the third virtual character.

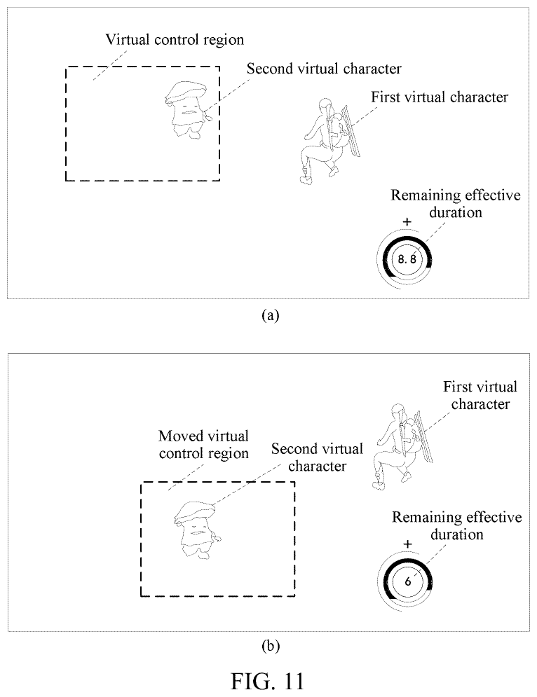

For example, it is assumed that after the target virtual skill released by the first virtual character hits the second virtual character, the virtual control region shown in (a) in FIG. 11 is formed in the virtual game scene. A region range and a region position of the virtual control region may be fixed, or may move as the second virtual character, for example, move from a position shown in (a) in FIG. 11 to a position shown in (b) in FIG. 11.

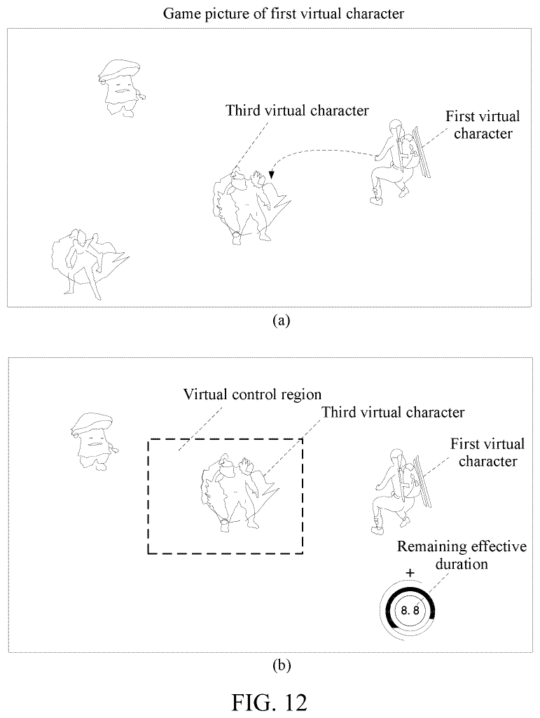

In addition to that the virtual control region may be formed by hitting the second virtual character, the virtual control region may also be formed by an attack operation on another virtual character. For example, as shown in (a) in FIG. 12, the virtual game scene includes a first virtual character, a second virtual character, a third virtual character. In a case that the target virtual skill released by the first virtual character hits the third virtual character, the virtual control region shown in (b) in FIG. 12 is formed in the virtual game scene.

The third virtual character may be, but is not limited to, a virtual character in a different camp from the first virtual character, and the third virtual character is a virtual character in the same camp as or a different camp from the second virtual character.

With reference to descriptions for the position and the size of the virtual control region in the foregoing embodiments, the virtual control region in this embodiment may be a fixed region, a region that moves with the third virtual character, or the like.

In addition to that the virtual control region may be formed by the target virtual skill released by the first virtual character hitting the second virtual character or the third virtual character, the forming of the virtual control region may also be triggered in the following manner.

When the second virtual character/the third virtual character performs the attack operation on the first virtual character and the first virtual character successfully dodges before being attacked by the second virtual character/the third virtual character, the virtual control region (the time-stop region) is also generated around the second virtual character or the third virtual character.

Through an attack operation or a dodge operation performed by each virtual character, a virtual control region having an effect of spatial fragmentation is formed on the game picture, which is beneficial for the first virtual character to effectively attack virtual characters of different camps in a process of displaying the virtual control region. The strong contrast of picture presentation shortens the response time of human-computer interaction, and improves the efficiency of human-computer interaction. In addition, it also increases the fun of the game, and enriches the diversity of the game picture.

In an example, the method may further include:
displaying the remaining effective duration of the virtual control region on a game picture of the second virtual character in a case that the second virtual character is located within the virtual control region; and/or
displaying, on the game picture of the second virtual character, prompt information of the attack operation performed by the first virtual character in a case that the second virtual character is located within the virtual control region, the prompt information being configured for prompting the second virtual character to dodge the attack operation performed by the first virtual character.

In a case that the virtual control region is formed, the remaining effective duration of the virtual control region is displayed on the game picture of the first virtual character, to remind the first virtual character that it can attack the second virtual character or another virtual character in the virtual control region before the remaining effective duration is greater than 0.

In addition, because the movement speed and/or the attack speed of the second virtual character located within the virtual control region is almost 0, to help the second virtual character dodge the attack operation performed by the first virtual character, prompt information of the attack operation performed by the first virtual character is displayed on the game picture of the second virtual character, to prompt the second virtual character to dodge when the first virtual character performs the attack operation.

By displaying different content on the game pictures of the first virtual character and the second virtual character, the response time of human-computer interaction can be shortened, thereby improving the efficiency of human-computer interaction. In addition, it makes the entire time-stop process full of variation and a sense of surprise, greatly improving the fun of the game battle phase.

In an implementation, the method further includes:
removing the movement restricted state and/or the attack restricted state of the second virtual character located within the virtual control region or reducing a range of the virtual control region in a case that the attack operation performed by the second virtual character hits the first virtual character; or
removing the movement restricted state and/or the attack restricted state of the second virtual character located within the virtual control region or reducing a range of the virtual control region in a case that an attack operation performed by a third virtual character hits the first virtual character, the third virtual character being a virtual character in the same camp as the second virtual character, and the third virtual character being located within the virtual control region or being located outside the virtual control region.

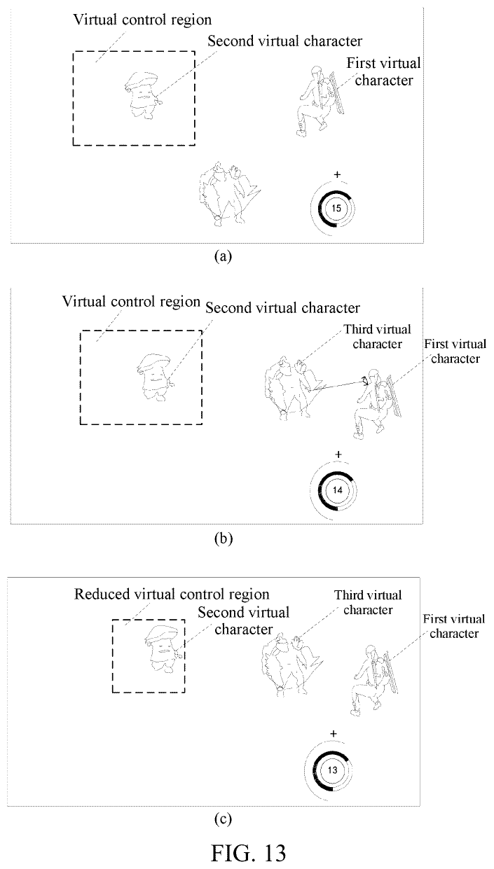

For example, assuming that the attack operation performed by the first virtual character hits the second virtual character, to form the virtual control region shown in (a) in FIG. 13, and the third virtual character in the same camps as the second virtual character hits the first virtual character by performing the attack operation, a movement speed and/or an attack speed of the second virtual character is increased. For example, the movement speed of the second virtual character is increased from an original 0.01 m/s to 2 m/s.

Alternatively, the region range of the virtual control region is reduced from (b) in FIG. 13 to (c) in FIG. 13, so that a quantity of virtual characters located within the virtual control region may be reduced. For example, assuming that there are three virtual characters originally located within the virtual control region, after the virtual control region is reduced, only one second virtual character remains.

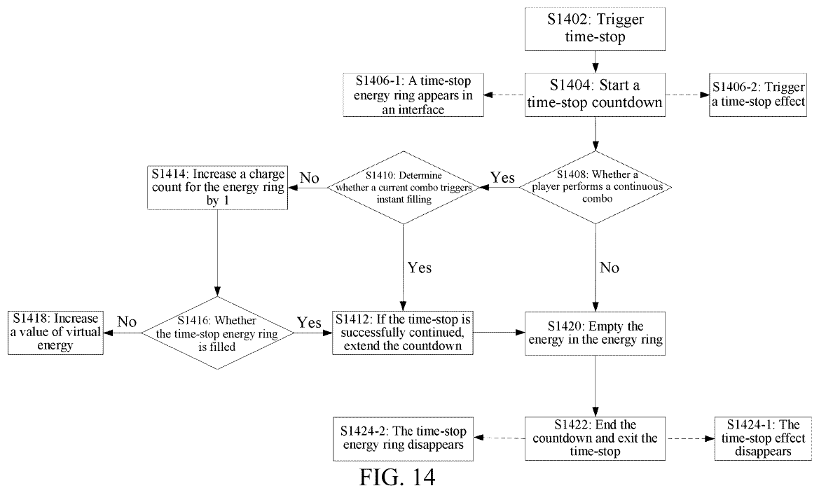

To more clearly understand the technical solutions in the embodiments of this disclosure, the game picture display method is further described below with reference to an overall flowchart shown in FIG. 14. Specific operations are as follows:
S1402: Trigger time-stop (which may also be understood as forming a virtual control region).

It includes, but is not limited to, two trigger manners: (1) After the first virtual character releases an attack skill and hits the second virtual character, a time-stop region is formed around the second virtual character. (2) If the first virtual character successfully dodges before being attacked by the second virtual character, the time-stop region is formed around the second virtual character.

A skill configuration table and a time-stop continuation table are pre-stored in a client to which a virtual character logs in. Assuming that the first virtual character releases a target skill to hit the second virtual character, whether the time-stop can be triggered is determined based on a target field corresponding to the target skill in the skill configuration table. If a value of the target field is 0, the time-stop is not triggered; or if the value of the target field is 1, the time-stop is triggered.

For example, assuming that the first virtual character performs a combo attack within a preset time (10s), it is determined, by querying the target field in the skill configuration table, that the time-stop is triggered.
S1404: Start a time-stop countdown after a time-stop region is formed, and simultaneously perform operation S1406-1 and operation S1406-2.
S1406-1: Display the time-stop countdown on a game picture.
S1406-2: Display a time-stop effect on the game picture.

For example, after the time-stop is triggered, a spherical space-time rupture effect with a radius of 20 meters is generated with the second virtual character as a center. In addition, after the time-stop is triggered, a time-stop countdown energy ring is displayed on the game picture. For example details, refer to FIG. 13.

A time-stop exclusive countdown timer is added in the backend. After the time-stop is triggered, the time-stop timer starts a countdown. If the countdown reaches 0, the time-stop ends, display of the time-stop region is canceled, and the movement speed and/or the attack speed of the virtual character in the time-stop region is restored to normal.
S1408: Determine whether a player performs a continuous combo.

If the player performs the continuous combo, perform operation S1410; otherwise, perform operation S1420.

The continuous combo may be, but is not limited to, a current attack operation performed by the first virtual character hitting the second virtual character, and a time interval between the current attack operation and a previous attack operation performed by the first virtual character that hits the second virtual character being less than or equal to a first preset duration.

Each time the first virtual character causes damage to the second virtual character, the following processing is performed:
(1) Record an effective time point of one current damage.
(2) Calculate a difference between time points of two adjacent damages.

If the difference is less than or equal to is, it is considered that the combo is successfully continued. If the difference is greater than is, it is considered that the combo fails to be continued, and energy accumulated in the energy ring is cleared. Meanwhile, if the first virtual character is injured, it is directly considered that the combo fails to be continued, and the energy accumulated in the energy ring is cleared.
S1410: Determine whether the current combo triggers instant filling.

If the instant filling is triggered, perform operation S1412; otherwise, perform operation S1414.
S1412: If the time-stop is successfully continued, extend the countdown.

A process of extending the countdown includes: In a case that it is determined that the combo is successfully continued, a time field in a time-stop continuation table pre-stored in the client is read, and the time field is used to determine that the time of the continuation is 5 s, 3 s, or the like.
S1414: Increase a charge count for the energy ring by 1.
S1416: Determine whether a time-stop energy ring is filled.

If the energy ring is filled, perform operation S1412; otherwise, perform operation S1418.
S1418: Increase a value of virtual energy in the time-stop energy ring.

For example, based on a situation in which a preset strong attack operation performed by the first virtual character hits the second virtual character located within the virtual control region, it is determined to increase by the preset value or the product of the preset value and N, N being a quantity of hit body parts of the second virtual character.
S1420: Clear the energy in the energy ring.

The energy in the energy ring is cleared after the combo fails to be continued or after the time-stop continuation is completed.

The combo failing to be continued herein may be, but is not limited to, a difference between time points at which the second virtual character is hit twice being greater than the first preset duration (for example, Is); or the first virtual character is injured (hit) in an attack operation process.
S1422: End the countdown, and exit the time-stop.

Operation S1424-1 and operation S1424-2 are simultaneously performed.
S1424-1: A time-stop effect disappears.

In other words, the virtual control region (the time-stop region) formed around the second virtual character disappears, and the movement speed and/or the attack speed of the second virtual character or another virtual character located within the virtual control region restores to normal.
S1424-2: The time-stop energy ring disappears.

For example, it restores to the game picture shown in (a) in FIG. 12.

By using the foregoing manner, in a process of displaying the remaining effective duration of the virtual control region, when the value of the virtual energy reaches a preset energy threshold, the remaining effective duration of the virtual control region can be increased by using the attack operation continuously performed by the first virtual character. In other words, in the process of displaying the remaining effective duration of the virtual control region, the count of the remaining effective duration can be increased by using the attack operation performed by the first virtual character, thereby simplifying the operation process of changing the remaining effective duration of the virtual control region in the related art, reducing the time consumed for forming the virtual control region again, and achieving the technical effect of improving the efficiency of displaying the game picture.

For ease of description, the foregoing method embodiments are described as a series of action combinations. However, this disclosure is not limited to the described action orders because some operations may be performed in another order or performed at the same time according to this disclosure. In addition, the embodiments described in this specification are all examples of embodiments, and the involved actions and modules are not necessarily required to this disclosure.

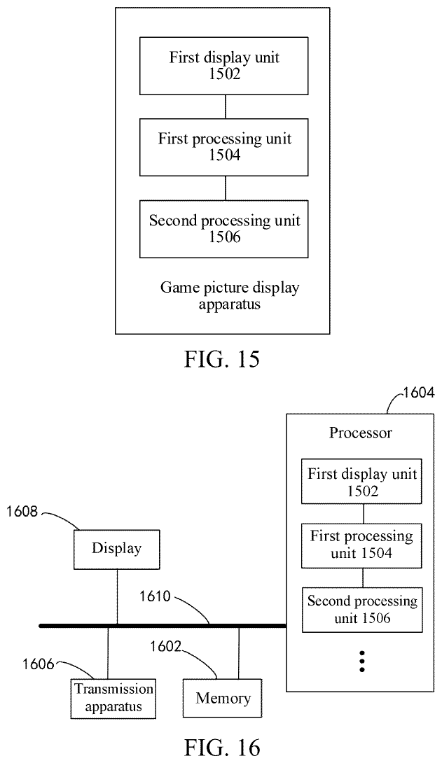

According to another aspect of the embodiments of this disclosure. an game picture display apparatus as shown in FIG. 15 is further provided. The apparatus may be configured to implement the game picture display method in the foregoing embodiments of this disclosure. For examples of content that is not described in detail in the apparatus embodiments, reference can be made to corresponding descriptions in the method embodiments, and details are not described herein again. As shown in FIG. 15, the apparatus may include:

a first display unit 1502, configured to display, on a game interface, a game picture corresponding to a virtual game scene from a target perspective of a first virtual character, the virtual game scene including the first virtual character and a second virtual character in a different camp from the first virtual character;

a first processing unit 1504, configured to: display, in response to a virtual control region formed by the first virtual character triggering a time-stop state in the virtual game scene, a remaining effective duration of the virtual control region on the game interface, the second virtual character located within the virtual control region being in a movement restricted state and/or an attack restricted state; and

a second processing unit 1506, configured to increase the remaining effective duration of the virtual control region in response to an attack operation performed by the first virtual character on the second virtual character satisfying a preset time-stop continuation condition.

In some embodiments, the second processing unit includes:
a first processing module, configured to increase a value of virtual energy in a case that a preset type of attack operation performed by the first virtual character hits the second virtual character located within the virtual control region; and
a second processing module, configured to increase the remaining effective duration of the virtual control region in a case that the value of the virtual energy reaches a preset energy threshold and the remaining effective duration is greater than 0.

In some embodiments, the first processing module includes:
a first processing submodule, configured to increase the value of the virtual energy in a case that a continuous attack operation performed by the first virtual character hits the second virtual character located within the virtual control region; or
a second processing submodule, configured to increase the value of the virtual energy in a case that a combined attack operation performed by the first virtual character hits the second virtual character located within the virtual control region.

In some embodiments, the first processing module includes:
a third processing submodule, configured to increase the value of the virtual energy in a case that a current attack operation performed by the first virtual character hits the second virtual character, and a time interval between the current attack operation and a previous attack operation performed by the first virtual character that hits the second virtual character is less than or equal to a first preset duration.

In some embodiments, the apparatus further includes:
a third processing unit, configured to reduce the value of the virtual energy or set the value of the virtual energy to 0 in a case that the current attack operation performed by the first virtual character hits the second virtual character, and the time interval between the current attack operation and the previous attack operation performed by the first virtual character that hits the second virtual character is greater than the first preset duration.

In some embodiments, the first processing module includes:
a fourth processing submodule, configured to increase the value of the virtual energy in a case that a set of attack operations sequentially performed by the first virtual character all hit the second virtual character within a second preset duration, the set of attack operations including a plurality of types of attack operations.

In some embodiments, the apparatus further includes:
a fourth processing unit, configured to reduce the value of the virtual energy or set the value of the virtual energy to 0 in a case that the attack operation performed by the second virtual character hits the first virtual character.

In some embodiments, the first processing module includes:
a fifth processing submodule, configured to: increase the value of the virtual energy by a preset value in a case that the preset type of attack operation performed by the first virtual character hits the second virtual character located within the virtual control region; or
increase the value of the virtual energy by a product of the preset value and N in a case that the preset type of attack operation performed by the first virtual character hits N parts of the second virtual character located within the virtual control region, N being a positive integer greater than or equal to 2; or
determine, based on a preset probability, whether to increase the value of the virtual energy to the preset energy threshold in a case that the preset type of attack operation performed by the first virtual character hits the second virtual character located within the virtual control region; increase the value of the virtual energy to the preset energy threshold in a case that it is determined to increase the value of the virtual energy to the preset energy threshold; and increase the value of the virtual energy by the preset value in a case that it is determined to not increase the value of the virtual energy to the preset energy threshold.

In some embodiments, the first processing module includes:
a sixth processing submodule, configured to determine, based on a preset first probability, whether to increase the value of the virtual energy to the preset energy threshold in a case that the value of the virtual energy falls within a first value range; and
a seventh processing submodule, configured to determine, based on a preset second probability, whether to increase the value of the virtual energy to the preset energy threshold in a case that the value of the virtual energy falls within a second value range, values within the first value range being all less than values within the second value range, and the first probability being less than the second probability.

In some embodiments, the apparatus further includes:
a fifth processing unit, configured to set the value of the virtual energy to 0 in a case that the remaining effective duration of the virtual control region is increased.

In some embodiments, the apparatus further includes:
a sixth processing unit, configured to: form the virtual control region in the virtual game scene in a case that a target virtual skill released by the first virtual character hits the second virtual character, the second virtual character being located within the virtual control region, and the virtual control region being a fixed region, or the virtual control region moving with the second virtual character; or
form the virtual control region in the virtual game scene in a case that a target virtual skill released by the first virtual character hits a third virtual character, the third virtual character being a virtual character in a different camp from the first virtual character, the third virtual character being in the same camp as or a different camp from the second virtual character, the third virtual character being located within the virtual control region, and the virtual control region being a fixed region, or the virtual control region moving with the third virtual character; or
form the virtual control region in the virtual game scene in a case that the first virtual character successfully dodges an attack operation performed by the second virtual character on the first virtual character, the second virtual character being located within the virtual control region, and the virtual control region being a fixed region, or the virtual control region moving with the second virtual character; and
form the virtual control region in the virtual game scene in a case that the first virtual character successfully dodges an attack operation performed by a third virtual character on the first virtual character, the third virtual character being a virtual character in a different camp from the first virtual character, the third virtual character being in the same camp as or a different camp from the second virtual character, the third virtual character being located within the virtual control region, and the virtual control region being a fixed region, or the virtual control region moving with the third virtual character.

In some embodiments, the apparatus further includes:
a second display unit, configured to: display the remaining effective duration of the virtual control region on a game picture of the second virtual character in a case that the second virtual character is located within the virtual control region; and/or
display, on the game picture of the second virtual character, prompt information of the attack operation performed by the first virtual character in a case that the second virtual character is located within the virtual control region, the prompt information being configured for prompting the second virtual character to dodge the attack operation performed by the first virtual character.

In some embodiments, the apparatus further includes:
a seventh processing unit, configured to: increase a movement speed and/or an attack speed of the second virtual character located within the virtual control region or reduce a range of the virtual control region in a case that the attack operation performed by the second virtual character hits the first virtual character; or
increase a movement speed and/or an attack speed of the second virtual character located within the virtual control region or reduce a range of the virtual control region in a case that an attack operation performed by a third virtual character hits the first virtual character, the third virtual character being a virtual character in the same camp as the second virtual character, and the third virtual character being located within the virtual control region or being located outside the virtual control region.

The apparatus is applied to a process of displaying the remaining effective duration of the virtual control region, and when the value of the virtual energy reaches the preset energy threshold, the remaining effective duration of the virtual control region can be increased by using the attack operation continuously performed by the first virtual character. In other words, in the process of displaying the remaining effective duration of the virtual control region, the count of the remaining effective duration can be increased by using the attack operation performed by the first virtual character, thereby simplifying the operation process of changing the remaining effective duration of the virtual control region in the related art, reducing the time consumed for forming the virtual control region again, and achieving the technical effect of improving the efficiency of displaying the game picture.

For examples of the embodiments of the game picture display apparatus herein, reference can be made to the embodiments of the game picture display method, and details are not described herein again.

According to still another aspect of the embodiments of this disclosure, an electronic device for implementing the foregoing game picture display method is further provided. The electronic device may be the terminal device shown in FIG. 16. In this embodiment, an example in which the electronic device is a backend device is used for description. As shown in FIG. 16, the electronic device includes a memory 1602 and processing circuitry (for example, a processor 1604). The memory 1602 has a computer program stored therein, and the processor 1604 is configured to perform the operations in any one of the foregoing method embodiments through the computer program.

In some embodiments, in this embodiment, the electronic device may be located within at least one of a plurality of network devices in a computer network.

In some embodiments, in this embodiment, the processor may be configured to perform the following operations through the computer program.
S1: Display, on a game interface, a game picture corresponding to a virtual game scene from a target perspective of a first virtual character, the virtual game scene including the first virtual character and a second virtual character in a different camp from the first virtual character.
S2: Display, in response to a virtual control region formed by the first virtual character triggering a time-stop state in the virtual game scene, a remaining effective duration of the virtual control region on the game interface, the second virtual character located within the virtual control region being in a movement restricted state and/or an attack restricted state.
S3: Increase the remaining effective duration of the virtual control region in response to an attack operation performed by the first virtual character on the second virtual character satisfying a preset stop-time continuation condition.

In some embodiments, a person of ordinary skill in the art may understand that, the structure shown in FIG. 16 is only an example. The electronic apparatus and the electronic device may be a target terminal such as a smartphone (for example, an Android phone or an iOS phone), a tablet computer, a palmtop computer, a mobile Internet device (MID), or a PAD. FIG. 16 does not limit the structures of the electronic apparatus and the electronic device. For example, the electronic apparatus and the electronic device may further include more or fewer components (such as a network interface) than those shown in FIG. 16, or have a configuration different from that shown in FIG. 16.

The memory 1602 may be configured to store a software program and a module, for example, a program instruction/module corresponding to the method and game picture display apparatus in the embodiments of this disclosure, and the processor 1604 runs the software program and the module stored in the memory 1602, to perform various functional applications and data processing, that is, implement the foregoing game picture display method. The memory 1602 may include a high-speed random access memory, and may further include a non-volatile memory such as one or more magnetic storage apparatuses, a flash memory, or another non-volatile solid-state memory. In some embodiments, the memory 1602 may further include memories remotely disposed relative to the processor 1604, and these remote memories may be connected to a terminal through a network. Examples of the network include, but not limited to, the Internet, an intranet, a local area network, a mobile communication network, and a combination thereof. The memory 1602 may be specifically configured to store, but is not limited to, a game picture corresponding to a target perspective, a remaining effective duration, a movement speed of a virtual character, and the like. In an example, as shown in FIG. 16, the memory 1602 may include, but is not limited to, the first display unit 1502, the first processing unit 1504, and the second processing unit 1506 in the foregoing game picture display apparatus. In addition, the memory 1602 may further include, but is not limited to, other modules and units in the foregoing game picture display apparatus, and details are not described herein again in this example.

In some embodiments, the transmission apparatus 1606 is configured to receive or send data through a network. Specific examples of the network include a wired network and a wireless network. In an example, the transmission apparatus 1606 includes a network interface controller (NIC). The NIC may be connected to another network device and a router by using a network cable, to communicate with the Internet or a local area network. In an example, the transmission apparatus 1606 is a radio frequency (RF) module, and is configured to communicate with the Internet in a wireless manner.

In addition, the electronic device further includes: a display 1608, configured to display orientation prompt information of the target sound; and a connection bus 1610, configured to connect various module components in the electronic device.

In some other embodiments, the target terminal or server may be a node in a distributed system. The distributed system may be a blockchain system. The blockchain system may be a distributed system formed by a plurality of nodes connected in the form of network communication. A peer to peer (P2P) network may be formed between nodes. A computing device in any form, for example, an electronic device such as a server or a terminal, may become a node in the blockchain system by joining the P2P network.

According to another aspect of the embodiments of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, so that the computer device performs the game picture display method provided in various implementations of the server verification processing and other aspects, the computer program being configured to perform the operations in any one of the foregoing method embodiments when running.

In some embodiments, in this embodiment, the computer-readable storage medium, such as a non-transitory computer-readable storage medium, may be configured to store a computer program configured for performing the following operations:
S1: Display, on a game interface, a game picture corresponding to a virtual game scene from a target perspective of a first virtual character, the virtual game scene including the first virtual character and a second virtual character in a different camp from the first virtual character.
S2: Display, in response to a virtual control region formed by the first virtual character triggering a time-stop state in the virtual game scene, a remaining effective duration of the virtual control region on the game interface, the second virtual character located within the virtual control region being in a movement restricted state and/or an attack restricted state.
S3: Increase the remaining effective duration of the virtual control region in response to an attack operation performed by the first virtual character on the second virtual character satisfying a preset stop-time continuation condition.

In this embodiment, a person of ordinary skill in the art may understand that all or some of the operations of the various methods in the foregoing embodiments may be implemented by a program instructing relevant hardware of the target terminal. The program may be stored in a computer-readable storage medium. The storage medium may include: a flash drive, a read-only memory (ROM), a random access memory (RAM), a magnetic disk, an optical disc, or the like.

The sequence numbers of the foregoing embodiments of this disclosure are merely for description purpose, and do not indicate the preference of the embodiments.

When the integrated unit in the foregoing embodiments is implemented in the form of a software functional unit and sold or used as an independent product, the integrated unit may be stored in the foregoing computer-readable storage medium. Based on such an understanding, the technical solutions of this disclosure may be implemented in a form of a software product. The computer software product is stored in a storage medium and includes several instructions for instructing one or more computer devices (which may be a personal computer, a server, a network device, or the like) to perform all or some of operations of the foregoing methods in the embodiments of this disclosure.

In the foregoing embodiments of this disclosure, the descriptions of the embodiments have respective focuses. For a part that is not described in detail in an embodiment, reference may be made to related descriptions in other embodiments.

In the several embodiments provided in this disclosure, a disclosed client may be implemented in another manner. The described apparatus embodiments are merely examples. For example, the unit division is merely logical function division and there may may be another division manner in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in an electronic form or another form.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit. The integrated unit may be implemented in a form of hardware, or may be implemented in a form of a software functional unit.

In the specification, claims, and accompanying drawings of this disclosure, the terms such as “first”, “second”, “third”, “fourth”, “1”, and “2” (if existing) are intended to distinguish between similar objects but do not necessarily indicate a specific order or sequence. Data used in such a way is interchangeable in proper circumstances, so that the embodiments of this disclosure described herein can be implemented in other orders than the order illustrated or described herein.

The foregoing descriptions are merely some embodiments of this disclosure, and a person of ordinary skill in the art may make various improvements and modifications without departing from the spirit of this disclosure. All such improvements and refinements shall fall within the scope of this disclosure.

What is claimed is:

1. A game display method, comprising:
outputting for display, on a game interface, a virtual game scene of a virtual environment from a target perspective of a first virtual character, the virtual game scene including a second virtual character;
outputting for display, based on a virtual control region formed by the first virtual character triggering a time-stop state in the virtual game scene, a remaining effective duration of the virtual control region on the game interface, the second virtual character located within the virtual control region being placed in a restricted state; and
increasing, by processing circuitry, the remaining effective duration of the virtual control region based on an attack operation performed by the first virtual character on the second virtual character satisfying a preset time-stop continuation condition.

2. The method according to claim 1, wherein the increasing comprises:
increasing the remaining effective duration of the virtual control region when the attack operation performed by the first virtual character on the second virtual character triggers an additional time-stop state and the remaining effective duration is greater than 0.

3. The method according to claim 1, wherein the increasing comprises:
increasing a value of virtual energy based on a preset type of attack operation performed by the first virtual character hitting the second virtual character located within the virtual control region; and
increasing the remaining effective duration of the virtual control region based on the value of the virtual energy reaching a preset energy threshold and the remaining effective duration is greater than 0.

4. The method according to claim 3, wherein the increasing the value of the virtual energy comprises:
increasing the value of the virtual energy based on at least one of (i) a continuous attack operation performed by the first virtual character hitting the second virtual character located within the virtual control region, or (ii) a combined attack operation performed by the first virtual character hitting the second virtual character located within the virtual control region.

5. The method according to claim 4, wherein the increasing the value of the virtual energy comprises:
increasing the value of the virtual energy based on a current attack operation performed by the first virtual character hitting the second virtual character, and a time interval between the current attack operation and a previous attack operation performed by the first virtual character that hits the second virtual character being less than or equal to a first duration.

6. The method according to claim 5, further comprising:
reducing the value of the virtual energy based on the current attack operation performed by the first virtual character hitting the second virtual character, and the time interval between the current attack operation and the previous attack operation performed by the first virtual character that hits the second virtual character being greater than the first duration.

7. The method according to claim 4, wherein the increasing the value of the virtual energy comprises:
increasing the value of the virtual energy based on a set of attack operations sequentially performed by the first virtual character all hitting the second virtual character within a second duration, the set of attack operations including a plurality of types of attack operations.

8. The method according to claim 3, further comprising:
reducing the value of the virtual energy based on the attack operation performed by the second virtual character hitting the first virtual character.

9. The method according to claim 3, wherein the increasing the value of the virtual energy comprises:
increasing the value of the virtual energy based on N when the preset type of attack operation performed by the first virtual character hits N parts of the second virtual character located within the virtual control region, N being a positive integer greater than or equal to 2.

10. The method according to claim 3, wherein the increasing the value of the virtual energy comprises:
determining, based on a preset probability, whether to increase the value of the virtual energy to the preset energy threshold when the preset type of attack operation performed by the first virtual character hits the second virtual character located within the virtual control region.

11. The method according to claim 10, wherein the determining whether to increase the value of the virtual energy to the preset energy threshold comprises:
determining, based on a preset first probability, whether to increase the value of the virtual energy to the preset energy threshold based on the value of the virtual energy falling within a first value range; and
determining, based on a preset second probability, whether to increase the value of the virtual energy to the preset energy threshold based on the value of the virtual energy falling within a second value range, the first value range being less than the second value range, and the first probability being less than the second probability.

12. The method according to claim 3, further comprising:
setting the value of the virtual energy to 0 based on the remaining effective duration of the virtual control region being increased.

13. The method according to claim 1, further comprising:
removing the restricted state of the second virtual character located within the virtual control region or reducing a range of the virtual control region when the first virtual character is hit by another attack operation.

14. The method according to claim 1, wherein the game interface displays an energy ring that is associated with the virtual control region formed by the first virtual character triggering the time-stop state in the virtual game scene;
the energy ring includes a ring body and a central region located on an inner side of the ring body;
the remaining effective duration of the virtual control region is displayed on the central region; and
the ring body is configured to display a value of virtual energy.

15. A processing apparatus, comprising:
processing circuitry configured to:
output for display, on a game interface, a virtual game scene of a virtual environment from a target perspective of a first virtual character, the virtual game scene including a second virtual character;
output for display, based on a virtual control region formed by the first virtual character triggering a time-stop state in the virtual game scene, a remaining effective duration of the virtual control region on the game interface, the second virtual character located within the virtual control region being placed in a restricted state; and
increase the remaining effective duration of the virtual control region based on an attack operation performed by the first virtual character on the second virtual character satisfying a preset time-stop continuation condition.

16. A non-transitory computer-readable storage medium storing instructions which when executed by a processor cause the processor to perform:
outputting for display, on a game interface, a virtual game scene of a virtual environment from a target perspective of a first virtual character, the virtual game scene including a second virtual character;
outputting for display, based on a virtual control region formed by the first virtual character triggering a time-stop state in the virtual game scene, a remaining effective duration of the virtual control region on the game interface, the second virtual character located within the virtual control region being placed in a restricted state; and
increasing, by processing circuitry, the remaining effective duration of the virtual control region based on an attack operation performed by the first virtual character on the second virtual character satisfying a preset time-stop continuation condition.

17. The non-transitory computer-readable storage medium according to claim 16, wherein the increasing comprises:
increasing the remaining effective duration of the virtual control region when the attack operation performed by the first virtual character on the second virtual character triggers an additional time-stop state and the remaining effective duration is greater than 0.

18. The non-transitory computer-readable storage medium according to claim 16, wherein the increasing comprises:
increasing a value of virtual energy based on a preset type of attack operation performed by the first virtual character hitting the second virtual character located within the virtual control region; and
increasing the remaining effective duration of the virtual control region based on the value of the virtual energy reaching a preset energy threshold and the remaining effective duration is greater than 0.

19. The non-transitory computer-readable storage medium according to claim 18, wherein the increasing the value of virtual energy comprises:
increasing the value of the virtual energy based on at least one of (i) a continuous attack operation performed by the first virtual character hitting the second virtual character located within the virtual control region, or (ii) a combined attack operation performed by the first virtual character hitting the second virtual character located within the virtual control region.

20. The non-transitory computer-readable storage medium according to claim 19, wherein the increasing the value of the virtual energy comprises:
increasing the value of the virtual energy based on a current attack operation performed by the first virtual character hitting the second virtual character, and a time interval between the current attack operation and a previous attack operation performed by the first virtual character that hits the second virtual character being less than or equal to a first duration.
